(19) United States
(12) Patent Application Publication
(10) Pub. No.: US 2025/0304768 A1
(43) Pub. Date: Oct. 2, 2025

(54) RESIN MOLDED ARTICLE

(71) Applicant: HONDA MOTOR CO., LTD., Tokyo (JP)

(72) Inventors: Motoki SAKURAI, Tokyo (JP); Chiaki MORI, Tokyo (JP); Tomohiko SHIGIHARA, Tokyo (JP); Daichi TAKANO, Tokyo (JP); Daichi TSUNODA, Tokyo (JP); Kei TAKAMATSU, Tokyo (JP); Shoya FUSHIMA, Tokyo (JP)

(21) Appl. No.: 19/059,287

(22) Filed: Feb. 21, 2025

(30) Foreign Application Priority Data
Mar. 28, 2024 (JP) 2024-053293

(51) Int. Cl. C08K 7/00

(52) U.S. Cl. CPC C08K 7/00; C08K 2201/003; C08K 2201/016

(57) ABSTRACT

To provide a lustrous material-containing resin molded article that has less noticeable weld lines without requiring complicated processes. A resin molded article is produced using a specific lustrous material. Specifically, the resin molded article is produced using, as the lustrous material, glass flakes having cut surfaces, and having an average particle diameter of greater than or equal to 90 μm and an aspect ratio of less than or equal to 20. Alternatively, the resin molded article is produced using, as the lustrous material, aluminum flakes having an average particle diameter of 175 μm to 460 μm.

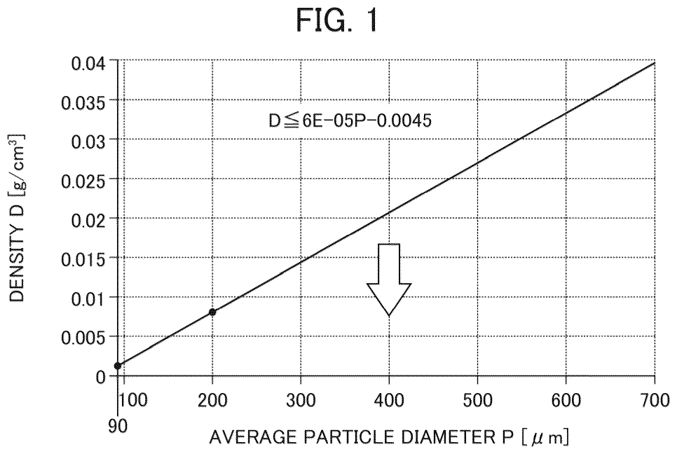

This application is based on and claims the benefit of priority from Japanese Patent Application No. 2024-053293, filed on 28 Mar. 2024, the content of which is incorporated herein by reference.

### BACKGROUND OF THE INVENTION

### Field of the Invention

The present invention relates to a resin molded article.

### Related Art

In recent years, efforts have been intensifying towards a significant reduction in waste generation through waste prevention, reduction, recycling, and reuse. In pursuit of this goal, research and development regarding recycling are being conducted.

Conventionally, painting has been used as a method for increasing the appearance quality of resin molded articles. However, the use of painting raises concerns about environmental burdens, such as emissions of volatile organic compounds, and also leads to increased labor, which results in higher costs. For example, painting may be applied to a resin molded article that is used as an exterior component of an automobile. In this case, there is a possibility that the paint coating could peel off due to an external impact such as a collision. Furthermore, from the perspective of resin recycling, alternative technologies to painting are desired.

Some alternative technologies to painting are therefore being considered, and one such method that has been proposed involves incorporating a lustrous material into a resin to be molded to impart a luster finish to the resin molded article. For example, Japanese Unexamined Patent Application, Publication No. H02-153966 proposes, as a lustrous material, a lustrous resin molding material containing flake-shaped glass, or glass flakes, having a diameter-to-thickness aspect ratio of greater than or equal to 10 and an average particle size of greater than or equal to 20 μm.

In particular, many resin molded components for automobiles are obtained through injection molding. In the injection molding, molten resin is made to flow within a mold. Consequently, weld lines, which are linear (streak-like) patterns, may form in areas where molten resin streams merge.

In the case of a resin having a lustrous material incorporated therein, in particular, the lustrous material flows as molten resin flows within a mold. The lustrous material flows in the surface direction of the molded article in areas where resin streams flow normally, but flows in the thickness direction of the molded article in areas where resin streams merge. As a result, the molded article may exhibit a difference in luster between the normal stream areas and the merged stream areas, making weld lines significantly noticeable.

To deal with such a problem, Japanese Unexamined Patent Application, Publication No. 2012-040811 proposes a method involving placing, in a shaping mold, and melting mixture pellets in which particles of an anisotropic filler are dispersed while being uniaxially oriented, thereby controlling the orientation direction of the anisotropic filler.
Patent Document 1: Japanese Unexamined Patent Application, Publication No. H02-153966
Patent Document 2: Japanese Unexamined Patent Application, Publication No. 2012-040811

### SUMMARY OF THE INVENTION

However, the method described in Japanese Unexamined Patent Application, Publication No. 2012-040811 requires a process for preparing in advance the mixture pellets in which the particles of the anisotropic filler are dispersed while being uniaxially oriented and a process for placing the mixture pellets in the shaping mold. As such, the method is complicated, involving these additional processes.

The present invention was made in view of the related art described above, and an object thereof is to provide a lustrous material-containing resin molded article that has less noticeable weld lines without requiring complicated processes. Furthermore, the present invention contributes to a significant reduction in waste generation.

In order to achieve the object described above, the inventors of the present invention have made intensive studies. As a result, the inventors found that it is possible to obtain a resin molded article that has less noticeable weld lines without requiring complicated processes by producing the resin molded article using a specific lustrous material. Thus, the inventors completed the present invention.

Specifically, the present invention includes the following aspects.

[1]
A resin molded article containing a lustrous material, the lustrous material being glass flakes having cut surfaces, the glass flakes having an average particle diameter of greater than or equal to 90 μm and an aspect ratio of less than or equal to 20.
[2]
The resin molded article according to [1], wherein a density D (g/cm³) of the glass flakes in the resin molded article and an average particle diameter P (μm) of the glass flakes satisfy Formula (1) shown below:

$$D \leq 6 E - 05 P - 0.0045 . \qquad Formula ( 1 )$$

[3]
The resin molded article according to [2], wherein the density D of the glass flakes in the resin molded article is greater than or equal to 0.0001 (g/cm³).
[4]
A resin molded article containing a lustrous material, the lustrous material being aluminum flakes having an average particle diameter of 175 μm to 460 μm.
[5]
The resin molded article according to [4], wherein a density D of the aluminum flakes in the resin molded article is 0.0001 (g/cm³) to 0.012 (g/cm³).

According to the present invention, it is possible to provide a lustrous material-containing resin molded article that has less noticeable weld lines without requiring complicated processes.

### BRIEF DESCRIPTION OF THE DRAWINGS

FIGURE shows the relationship between an average particle diameter P (μm) and a density D (g/cm³) of glass flakes in a resin molded article.

### DETAILED DESCRIPTION OF THE INVENTION

The following describes resin molded articles according to embodiments of the present invention in detail. However, the embodiments of the present invention are not limited to the following description.

### First Embodiment

A resin molded article according to a first embodiment contains a lustrous material. As the lustrous material, glass flakes having an average particle diameter of greater than or equal to 90 μm and an aspect ratio of less than or equal to 20 are used. The glass flakes have cut surfaces resulting from cutting during manufacturing thereof, and these cut surfaces exhibit luster characteristics as do primary or other surfaces. It is possible to reduce the difference in luster between the cut surfaces and the primary surfaces of the glass flakes by adjusting the glass flakes to a specific aspect ratio such as described above. It is possible to reduce the difference in luster between merged stream areas and other general areas (normal stream areas) of the resin molded article by adjusting the glass flakes to a specific average particle diameter such as described above.

### <Resin>

No particular limitations are placed on the resin that is used for the resin molded article according to the first embodiment. The resin can be selected as appropriate in consideration of appearance quality, mechanical properties, costs, and other factors required for the molded article. Examples of resins that can be used for the resin molded article according to the present embodiment include polypropylene (PP), acrylonitrile butadiene styrene copolymer resin (ABS), and polystyrene (PS). The resin that is used for the resin molded article according to the first embodiment may be a translucent resin. Furthermore, a blend of different resins may be used.

### <Lustrous Material>

The lustrous material that is used for the resin molded article according to the first embodiment is mixed with the resin and dispersed in the resin molded article. The lustrous material imparts, for example, a glossy, metallic, or depth-like appearance to the molded article through actions such as reflection, transmission, and refraction. The lustrous material may be colored.

### (Type)

Glass flakes are used as the lustrous material for the resin molded article according to the first embodiment. Glass flakes are readily available and excellent in terms of handleability. The glass flakes have cut surfaces resulting from cutting during manufacturing thereof, and these cut surfaces exhibit luster characteristics as do primary or other surfaces.

### (Shape)

In terms of the shape, the glass flakes that are used as the lustrous material for the resin molded article according to the first embodiment are flake-shaped particles (flakes) each having differing short and long diameters.

### (Cut Surfaces)

The cut surfaces of the glass flakes that are used as the lustrous material for the resin molded article according to the first embodiment (for example, surfaces in the thickness direction in the case of flake-shaped particles) have luster characteristics as do the primary surfaces.

Since the cut surfaces of the glass flakes that are used as the lustrous material for the resin molded article according to the first embodiment have luster characteristics as do the primary surfaces, it is possible to ensure luster even if the lustrous material flows in the thickness direction of the molded article in areas where molten resin streams merge during the molding. As a result, the areas where molten resin streams merge can be prevented from being darker, making weld lines in the molded article less noticeable.

### (Average Particle Diameter)

The glass flakes that are used as the lustrous material for the resin molded article according to the first embodiment have an average particle diameter of greater than or equal to 90 μm. In a configuration in which the glass flakes have an average particle diameter of greater than or equal to 90 μm, it is possible to reduce the number of particles of the glass flakes that are contained in the resin molded article, compared to a configuration in which glass flakes having a smaller average particle diameter are blended at the same content or density. Thus, it is possible to reduce the amount of particles oriented in the thickness direction of the molded article in the areas where molten resin streams merge. As a result, the difference in luster between the normal stream areas and the merged stream areas is reduced, making weld lines in the molded article less noticeable.

The average particle diameter of the glass flakes that are used as the lustrous material for the resin molded article according to the first embodiment may be greater than or equal to 100 μm, greater than or equal to 120 μm, greater than or equal to 140 μm, greater than or equal to 160 μm, or greater than or equal to 180 μm. As for the upper limit, the average particle diameter of the glass flakes is set to less than or equal to 5000 μm from the perspective of the feasibility of injection molding.

It should be noted that the average particle diameter of the glass flakes mentioned above means the “average long diameter” of the flake-shaped particles of the glass flakes. The average particle diameter can be calculated by cutting the molded article and observing a cut surface using an electron microscope. Specifically, image processing software is used to binarize regions corresponding to the glass flakes and the other regions in the observation field of view. Then, 20 particles of the lustrous material are selected at random, and the longest diameter is measured for each particle. The average value of the thus obtained measurement values is taken as the average long diameter of the glass flakes.

### (Aspect Ratio)

The glass flakes that are used as the lustrous material for the resin molded article according to the first embodiment have an aspect ratio of less than or equal to 20. In a configuration in which the glass flakes have an aspect ratio of less than or equal to 20, it is possible to reduce the difference in luster between the cut surfaces of the glass flakes (surfaces in the thickness direction of the flake-shaped particles) and the other areas. Thus, even if the glass flakes flow in the thickness direction of the molded article in the areas where molten resin streams merge during the molding, it is possible to reduce the difference in luster between the normal stream areas and the merged stream areas of the molded article, making weld lines in the molded article less noticeable.

The aspect ratio of the glass flakes that are used as the lustrous material for the resin molded article according to the first embodiment may be less than or equal to 18, less than or equal to 16, less than or equal to 14, less than or equal to 12, less than or equal to 10, less than or equal to 8, less than or equal to 6, less than or equal to 4, or less than or equal to 2.

It should be noted that the aspect ratio as referred to herein means the ratio of the long diameter (major axis diameter) to the short diameter (minor axis diameter) of particles. In general, the larger the aspect ratio of the lustrous material used in the resin molded article is, the higher the luster effect imparted to the resulting molded article, and the smaller the aspect ratio is, the less noticeable the orientation inconsistency.

### (Density)

The glass flakes that are used as the lustrous material for the resin molded article according to the first embodiment are adjusted to a specific density in the resin molded article. Preferably, the density D (g/cm³) of the glass flakes in the resin molded article and the average particle diameter P (μm) of the glass flakes satisfy Formula (1) shown below. D≤6E-05P−0.0045 . . . Formula (1)

Regarding the present embodiment, an experiment was conducted using glass flakes having different average particle diameters. Specifically, resin molded articles were prepared by varying the average particle diameter and the content, i.e., the density of the glass flakes. Then, each of the thus prepared resin molded articles was observed to determine whether or not the resin molded article had luster characteristics and whether or not the resin molded article had noticeable weld lines. Then, based on the results of resin molded articles that had luster characteristics and had least noticeable weld lines (specifically, Example 2 described below having a glass flake density representing the threshold where the evaluation results of resin molded articles containing glass flakes with an average particle diameter of 90 μm change and Example 11 described below having a glass flake density representing the threshold where the evaluation results of resin molded articles containing glass flakes with an average particle diameter of 200 μm change), average particle diameters and densities of the glass flakes were plotted to create an approximate formula. Aa a result, a graph indicating the relationship represented by Formula (1) was obtained as shown in FIGURE.

A resin molded article in which the density D (g/cm³) of the glass flakes, which are used as the lustrous material for the resin molded article according to the first embodiment, does not satisfy Formula (1) shown above contains a large number of particles of the glass flakes. Consequently, the molded article exhibits higher luster in the normal stream areas, resulting in a greater difference in luster between the normal stream areas and the merged stream areas, and thus making weld lines noticeable. By contrast, a resin molded article in which the density D (g/cm³) of the glass flakes, which are used as the lustrous material for the resin molded article according to the first embodiment, satisfies Formula (1) shown above can achieve a reduction in difference in luster between the normal stream areas and the merged stream areas of the molded article, resulting in a reduction in visibility of weld lines.

The resin molded article according to the first embodiment preferably contains the glass flakes as the lustrous material in an amount of greater than or equal to 0.01 wt % with respect to 100 wt % of the resin molded article. In other words, the density of the glass flakes in the resin molded article is preferably greater than or equal to 0.0001 (g/cm³).

In the case of a resin molded article that contains glass flakes as the lustrous material for the resin molded article according to the first embodiment in an amount of less than 0.01 wt % with respect to 100 wt % of the resin molded article, i.e., in the case of a resin molded article in which the density of the glass flakes is less than 0.0001 (g/cm³), it is difficult to implement control to prevent non-uniform distribution of the glass flakes within the resin (base material).

The glass flake content may be greater than or equal to 0.1 wt %. In other words, the density of the glass flakes in the resin molded article may be greater than or equal to 0.001 (g/cm³). The upper limit for the density of the glass flakes in the resin molded article can be calculated from the upper limit for the average particle diameter of the glass flakes, which is 5000 μm, in accordance with Formula (1) shown above, and is specifically 0.296 (g/cm³).

### <Other Components>

The resin molded article according to the first embodiment may contain, for example, a component that forms the base material of the molded article, such as an elastomer, a lustrous material other than glass flakes, a pigment, and various other additives, as necessary. Examples of additives include an ultraviolet absorber, an antioxidant, an antifoamer, an antisettling agent, a dispersant, and a surface modifier.

### Second Embodiment

A resin molded article according to a second embodiment is a lustrous material-containing resin molded article, and aluminum flakes having a particle diameter of 175 μm to 460 μm are used as the lustrous material.

### <Resin>

No particular limitations are placed on the resin that is used for the resin molded article according to the second embodiment, and the same resin as the resin for the resin molded article according to the first embodiment described above may be used.

### <Lustrous Material>

The lustrous material that is used for the resin molded article according to the second embodiment is aluminum flakes (flake-shaped aluminum particles) having an average particle diameter of 175 μm to 460 μm. Using aluminum particles as the lustrous material for the resin molded article according to the second embodiment gives the resin molded article a depth-like, metallic appearance.

### (Shape)

The lustrous material that is used for the resin molded article according to the second embodiment is aluminum flakes. As such, in terms of the shape, the lustrous material is flake-shaped particles (flakes) each having differing short and long diameters.

### (Average Particle Diameter)

The aluminum flakes that are used as the lustrous material for the resin molded article according to the second embodiment have an average particle diameter of 175 μm to 460 μm. In a configuration in which the aluminum flakes have an average particle diameter of 175 μm to 460 μm, it is possible to reduce the number of particles of the aluminum flakes that are contained in the resin molded article, compared to a configuration in which aluminum flakes having a smaller average particle diameter are blended at the same content (wt %). Thus, it is possible to reduce the amount of particles oriented in the thickness direction of the molded article in the areas where molten resin streams merge. As a result, the difference in luster between the normal stream areas and the merged stream areas is reduced, making weld lines in the molded article less noticeable.

The average particle diameter of the aluminum flakes that are used as the lustrous material for the resin molded article according to the second embodiment may be greater than or equal to 200 μm, greater than or equal to 250 μm, greater than or equal to 300 μm, greater than or equal to 350 μm, or greater than or equal to 400 μm.

It should be noted that the average particle diameter of the aluminum flakes mentioned above means the “average long diameter” of the flake-shaped particles of the aluminum flakes. The particle diameter of the aluminum flakes contained in the resin molded article can be determined by the same measurement method as in the resin molded article according to the first embodiment.

### (Aspect Ratio)

No particular limitations are placed on the aspect ratio of the aluminum flakes that are used as the lustrous material for the resin molded article according to the second embodiment. The aspect ratio of the aluminum flakes may be, for example, greater than or equal to 2 and less than or equal to 1000.

### (Density)

The density D (g/cm³) of the aluminum flakes, which are used as the lustrous material for the resin molded article according to the second embodiment, in the resin molded article is preferably 0.0001 (g/cm³) to 0.012 (g/cm³). A resin molded article in which the density D (g/cm³) of the aluminum flakes is within the aforementioned range can achieve a reduction in difference in luster between the normal stream areas and the merged stream areas of the molded article, resulting in a reduction in visibility of weld lines.

The resin molded article according to the second embodiment preferably contains the aluminum flakes as the lustrous material in an amount of greater than or equal to 0.01 wt % with respect to 100 wt % of the resin molded article.

### <Other Components>

The resin molded article according to the second embodiment may contain, for example, a component that forms the base material of the molded article, such as an elastomer, a lustrous material other than aluminum flakes, a pigment, and various other additives, as necessary. Examples of additives include an ultraviolet absorber, an antioxidant, an antifoamer, an antisettling agent, a dispersant, and a surface modifier.

### EXAMPLES

The following describes the present invention in further detail using working examples. However, the present invention is not limited to these working examples and various changes may be made without departing from or exceeding the spirit or scope of the present invention.

### <Materials>

Materials used in Examples and Comparative Examples are listed below.

### (Resin)

Methacrylic resin (product name “ACRYPET (registered trademark) IRK304 001”, manufactured by Mitsubishi Chemical Corporation)

### <Lustrous Material>

Glass flakes (product name “METASHINE (registered trademark)”, manufactured by Nippon Sheet Glass Co., Ltd.) Aluminum flakes (product name “Astro Flake (registered trademark)”, manufactured by Fukuda Metal Foil & Powder Co., Ltd.)

### Examples 1-1 to 1-12 and Comparative Examples 1-1 to 1-2

Resin molded articles were prepared through injection molding (temperature: 260° C., mold temperature: 60° C.) by varying the aspect ratio, the average particle diameter, and the thickness of the aforementioned glass flakes, which have cut surfaces, and adjusting the amount of the glass flakes to be contained with respect to the resin so that the density of the glass flakes in each resin molded article was as shown in Table 1.

### (Evaluation)

Each of the thus prepared resin molded articles was visually observed to determine whether or not the resin molded article had luster characteristics and whether or not the resin molded article had noticeable weld lines. The evaluation criteria were, in descending order, Evaluations A, B, C, and D, with Evaluation A indicating the highest evaluation result given to resin molded articles that had luster characteristics and had least noticeable weld lines. Evaluations A to C were deemed acceptable, and Evaluation D was deemed unacceptable. Table 1 shows the results.

TABLE 1

| | Aspect | Average particle | Thickness | Context | Density | Is Formula (1) | |
|---|---|---|---|---|---|---|---|
| | ratio | diameter[μm] | [μm] | [wt %] | [g/cm³] | satisfied? | Evaluation |
| Comparative | 20 | 20 | 1 | 0.1 | 0.001 | — | D |
| Example1-1 | | | | | | | |
| Comparative | 20 | 20 | 1 | 1 | 0.012 | — | D |
| Example1-2 | | | | | | | |
| Example1-1 | 18 | 90 | 5 | 0.05 | <0.001 | Satisfied | A |
| Example1-2 | 18 | 90 | 5 | 0.1 | 0.001 | Satisfied | A |
| Example1-3 | 18 | 90 | 5 | 0.2 | 0.002 | Not satisfied | B |
| Example1-4 | 18 | 90 | 5 | 0.5 | 0.006 | Not satisfied | C |
| Example1-5 | 18 | 90 | 5 | 1 | 0.012 | Not satisfied | C |
| Example1-6 | 18 | 90 | 5 | 1.5 | 0.017 | Not satisfied | C |
| Example1-7 | 20 | 200 | 10 | 0.2 | 0.002 | Satisfied | A |
| Example1-8 | 20 | 200 | 10 | 0.4 | 0.005 | Satisfied | A |
| Example1-9 | 20 | 200 | 10 | 0.5 | 0.006 | Satisfied | A |
| Example1-10 | 20 | 200 | 10 | 0.6 | 0.007 | Satisfied | A |
| Example1-11 | 20 | 200 | 10 | 0.7 | 0.008 | Satisfied | A |
| Example1-12 | 20 | 200 | 10 | 0.8 | 0.009 | Not satisfied | B |

To begin with, Comparative Example 1-1 and Comparative Example 1-2, in which glass flakes having an average particle diameter of less than 90 μm were used, were evaluated as D and deemed unacceptable, regardless of the glass flake content or density. The fact is, these resin molded articles had no luster characteristics. Examples 1-1 to 1-12 were all evaluated as A, B, or C and deemed acceptable. In particular, Example 1-1, Example 1-2, and Examples 1-7 to 1-11, in which Formula (1) was satisfied, were all evaluated as A.

These results confirmed that using glass flakes having an average particle diameter of greater than or equal to 90 μm and an aspect ratio of less than or equal to 20 allows for production of resin molded articles that have luster characteristics and have less noticeable weld lines. In particular, the results confirmed that adjusting the glass flakes so as to satisfy Formula (1) allows for production of resin molded articles that have excellent luster characteristics and have no noticeable weld lines.

### Examples 2-1 to 2-7 and Comparative Example 2-1

Resin molded articles were prepared through injection molding (temperature: 260° C., mold temperature: 60° C.) by varying the average particle diameter and the thickness of the aforementioned aluminum flakes, and adjusting the amount of the aluminum flakes to be contained with respect to the resin so that the density of the aluminum flakes in each resin molded article was as shown in Table 2.

### (Evaluation)

Each of the thus prepared resin molded articles was visually observed to determine whether or not the resin molded article had luster characteristics and whether or not the resin molded article had noticeable weld lines. The evaluation criteria were, in descending order, Evaluations A, B, and C, with Evaluation A indicating the highest evaluation result given to resin molded articles that had luster characteristics and had least noticeable weld lines. Evaluations A and B were deemed acceptable, and Evaluation C was deemed unacceptable. Table 2 shows the results.

TABLE 2

| | Average | | | | |
|---|---|---|---|---|---|
| | particle | Thickness | Content | Density | |
| | diameter[μm] | [μm] | [wt %] | [g/cm³] | Evaluation |
| Comparative | 90 | 1 | 0.4 | 0.005 | C |
| Example2-1 | | | | | |
| Example2-1 | 175 | 12 | 0.4 | 0.005 | A |
| Example2-2 | 175 | 12 | 1.6 | 0.019 | B |
| Example2-3 | 460 | 12 | 0.5 | 0.006 | A |
| Example2-4 | 460 | 12 | 1 | 0.012 | A |
| Example2-5 | 460 | 12 | 1.6 | 0.019 | B |
| Example2-6 | 460 | 12 | 2 | 0.024 | B |
| Example2-7 | 460 | 12 | 2.5 | 0.029 | B |

To begin with, Comparative Example 2-1, in which aluminum flakes having an average particle diameter of less than 175 μm were used, was evaluated as C and deemed unacceptable. Examples 2-1 to 2-7 were all evaluated as A or B and deemed acceptable. In particular, the resin molded articles of Example 2-1, Example 2-3, and Example 2-4, in which the density of the aluminum flakes was within the range of 0.0001 (g/cm³) to 0.012 (g/cm³), were all evaluated as A.

These results confirmed that using aluminum flakes having an average particle diameter of 175 μm to 460 μm allows for production of resin molded articles that have luster characteristics and have less noticeable weld lines. In particular, the results confirmed that adjusting the density of the aluminum flakes in resin molded articles within the range of 0.0001 (g/cm³) to 0.012 (g/cm³) allows for production of resin molded articles that have excellent luster characteristics and have no noticeable weld lines.

What is claimed is:

1. A resin molded article containing a lustrous material,
the lustrous material being glass flakes having cut surfaces,
the glass flakes having an average particle diameter of greater than or equal to 90 μm and an aspect ratio of less than or equal to 20.

2. The resin molded article according to claim 1, wherein a density D (g/cm³) of the glass flakes in the resin molded article and an average particle diameter P (μm) of the glass flakes satisfy Formula (1) shown below:
$$D \leq 6 E - 05 P - 0.0045 . \qquad Formula ( 1 )$$

3. The resin molded article according to claim 2, wherein the density D of the glass flakes in the resin molded article is greater than or equal to 0.0001 (g/cm³).

4. A resin molded article containing a lustrous material,
the lustrous material being aluminum flakes having an average particle diameter of 175 μm to 460 μm.

5. The resin molded article according to claim 4, wherein a density D of the aluminum flakes in the resin molded article is 0.0001 (g/cm³) to 0.012 (g/cm³).
